(19) United States
(12) Patent Application Publication
(10) Pub. No.: US 2010/0262763 A1
(43) Pub. Date: Oct. 14, 2010

(54) DATA ACCESS METHOD EMPLOYED IN MULTI-CHANNEL FLASH MEMORY SYSTEM AND DATA ACCESS APPARATUS THEREOF

(76) Inventors: Chao-Yin Liu, Hsinchu City (TW); Chia-Hua Liu, Taichung County (TW)

Correspondence Address: NORTH AMERICA INTELLECTUAL PROPERTY CORPORATION, P.O. BOX 506, MERRIFIELD, VA, 22116, US

(21) Appl. No.: 12/622,357

(22) Filed: Nov. 19, 2009

(30) Foreign Application Priority Data
Apr. 13, 2009 (TW) 098112177

(51) Int. Cl. G06F 12/00; G06F 12/02; G06F 13/28

(52) U.S. Cl. 711/103; 710/22; 711/E12.001; 711/E12.008

(57) ABSTRACT

A data access method used in a multi-channel flash memory system includes: respectively writing a plurality of data into a plurality of buffer areas of a buffer unit through direct memory accessing; and sequentially reading the plurality of data from the plurality of buffer areas, and respectively and synchronously storing the plurality of read data into the plurality of flash memory units, wherein each of the plurality of data is a data block protected by an error correction code (ECC).

### BACKGROUND OF THE INVENTION

1. Field of the Invention

The present invention relates to a data access mechanism, and more particularly, to a data access method employed in a multi-channel flash memory system and a data access apparatus thereof.

2. Description of the Prior Art

For a flash memory system, a host merely accesses one flash memory unit at a time, and accesses a next flash memory unit when the current flash memory unit is accessed completely. However, the data access delay time of the flash memory unit is much longer than the data transmission time between the host and the flash memory unit. Therefore, no matter whether the prior art design accesses only a single flash memory unit at a time or sequentially accesses a plurality of flash memory units, the conventional flash memory system needs to wait for a longer data transmission time to allow all of the flash memory units to finish reading or writing data. This longer data transmission time will inevitably decrease data processing efficiency of the flash memory system.

### SUMMARY OF THE INVENTION

Therefore, one of the objectives of the present invention is to provide a data access method employed in a multi-channel flash memory system and a data access apparatus thereof, to solve the afore-mentioned problem.

According to an embodiment of the present invention, a data access method used in a multi-channel flash memory system is disclosed. The data access method includes: respectively writing a plurality of data into a plurality of buffer areas of a buffer unit through direct memory accessing; and sequentially reading the plurality of data from the plurality of buffer areas, and respectively and synchronously storing the plurality of data read from the plurality of buffer areas into the plurality of flash memory units, wherein the plurality of data is data blocks protected by an error correction code (ECC).

According to another embodiment of the present invention, a data access apparatus employed in a multi-channel flash memory system is disclosed. The data access apparatus is coupled to a plurality of flash memory units, and includes a buffer unit and a control circuit. The buffer unit includes a plurality of buffer areas. The control circuit is coupled to the buffer unit, and implemented for controlling data reading/writing operations of the plurality of buffer areas of the buffer unit. The control circuit receives a plurality of data and respectively writes the plurality of data into the plurality of buffer areas of the buffer unit through direct memory accessing; in addition, the control circuit sequentially reads the plurality of data from the plurality of buffer areas, and respectively and synchronously stores the plurality of read data read from the plurality of buffer areas into the plurality of flash memory units, wherein the plurality of data is data blocks protected by an ECC.

As mentioned above, the benefit of the present invention lies in utilizing the data access apparatus to perform data accessing (reading/writing) operations upon a plurality of flash memory units synchronously, thereby decreasing the data access delay time of the flash memory units effectively as well as decreasing the hardware manufacturing cost of the buffer unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a data access apparatus according to an embodiment of the present invention.

FIG. 2 is a diagram illustrating a data writing operation performed by the data access apparatus shown in FIG. 1.

FIG. 3 is a diagram illustrating an operation of the access apparatus shown in FIG. 1 which performs data writing upon part of the flash memory units.

FIG. 4 is a diagram illustrating an operation of the data access apparatus shown in FIG. 1 which performs data reading upon flash memory units.

### DETAILED DESCRIPTION

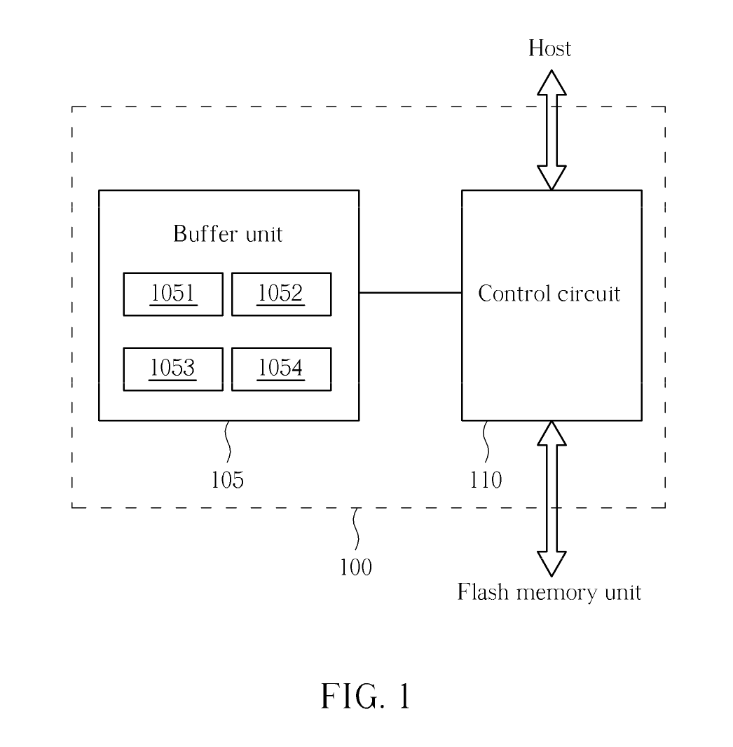

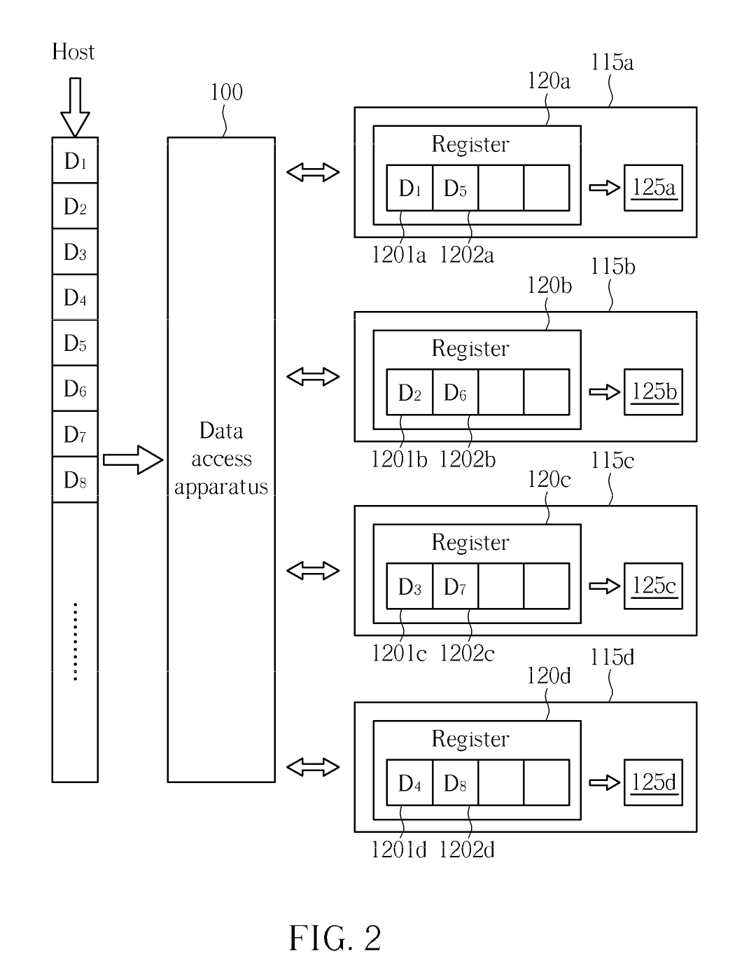

Please refer to FIG. 1 in conjunction with FIG. 2. FIG. 1 is a diagram illustrating a data access apparatus 100 according to a first embodiment of the present invention. FIG. 2 is a diagram illustrating a data writing operation performed by the data access apparatus 100 shown in FIG. 1. As shown in FIG. 1, the data access apparatus 100 includes a buffer unit 105 and a control circuit 110. The data access apparatus 100 is used in a multi-channel flash memory system, and coupled to a plurality of flash memory units (e.g., an even number of flash memory units). The term “multi-channel” implies that the data access apparatus 100 is coupled to multiple flash memory units, and a host accesses the flash memory units synchronously through the data access apparatus 100. It should be noted that the number of flash memory units should not be considered as a limitation to the scope of the present invention. The buffer unit 105 includes a plurality of buffer areas. In this exemplary embodiment, four buffer areas 1051-1054 are shown for illustrative purposes only, but this number is by no means meant to be a limitation of the present invention. The buffer areas 1051-1054 respectively correspond to the flash memory units 115a-115d shown in FIG. 2, for temporarily storing the sector data to be written into the flash memory units 115a-115d. The control circuit 110 is coupled to the buffer unit 105, and implemented for controlling the data reading/writing operations of the flash memory units 115a-115d of the buffer unit 105. In this embodiment, the control circuit 110 controls the sector data stream to be written into the flash memory unit by the host.

As shown in FIG. 2, the data access apparatus 100 is coupled to the flash memory units 115a-115d, but, due to the propagation through the data access apparatus 100, the host can synchronously access (read/write) the flash memory units 115a-115d via the control circuit 110 and the buffer unit 105. In order words, the data steam with continuous logical block address (LBA) outputted by the host will be separately written into the flash memory units 115a-115d when the host performs the data writing operation. For example, when the host writes multiple data D₁-D₈ with continuous logical block addresses, the access apparatus 100 respectively and synchronously writes the data D₁-D₈ into the flash memory units 115a-115d, wherein the data D₁-Dₛ takes a size of a sector as a unit and each data include 512 bytes; that is, each of the data D₁-D_{g} is a data block protected by an error correction code (ECC), and the flash memory units 115a-115d operate at the same time. In detail, in order to achieve the purpose of synchronously writing data into multiple flash memory units, when the host writes the data, the control circuit 110 receives four data D₁-D₄ first and respectively writes the data D₁-D₄ into the buffer areas 1051-1054 of the buffer unit 105 through direct memory accessing (DMA), then, the control circuit 110 sequentially reads the data D₁-D₄ from the buffer areas 1051-1054, and respectively and synchronously stores the data D₁-D₄ into the flash memory units 115a-115d. Because the data D₁-D₄ are synchronously and respectively written into the flash memory units 115a-115d, the flash access delay time can be shortened effectively.

After being processed through the access apparatus 100, the data D1 is temporarily stored in a buffering area 1201a of an internal register 120a of the flash memory unit 115a, the data D₂ is temporarily stored in a buffering area 1201b of an internal register 120b of the flash memory unit 115b, the data D₃ is temporarily stored in a buffering area 1201c of an internal register 120c of the flash memory unit 115c, and the data D₄ is temporarily stored in a buffering area 1201d of an internal register 120d of the flash memory unit 115d, and so forth. Therefore, data D₅-D₈ are also synchronously and temporarily stored in the buffering areas 1201a-1201d of the internal registers 120a-120d of the flash memory units 115a-115d. In this embodiment, when each register of the registers 120a-120d temporarily stores four sector data, the four sector data are written into a corresponding physical sector block (shown as 125a-125d, respectively); however, this is not meant to be taken as a limitation of the present invention. For instance, if a page is defined to have a size of two sector data, the afore-mentioned register can temporarily store two sector data, and then writes the two sector data into a corresponding physical sector block, or each register can write the afore-mentioned sector data into the corresponding physical sector block based on the data size of each data (i.e., a size of the sector data). These alternative designs all obey the spirit of the present invention. As mentioned above, the access apparatus 100 separately and synchronously writes the plurality of data with continuous logical block addresses into the flash memory units 115a-115d; that is, when the access apparatus 100 writes a data into a flash memory unit and waits for a longer access delay time (i.e., a duration starting from writing a single data into a flash memory unit and ending at a completion of storing the single data in the flash memory unit is relatively long), the access apparatus 100 can also write another data into another flash memory unit at the same time, therefore, the access apparatus 100 can shorten the flash access delay time for the data writing operation. Taking this embodiment as an example, the flash access delay time can be reduced to a quarter of the original access delay time.

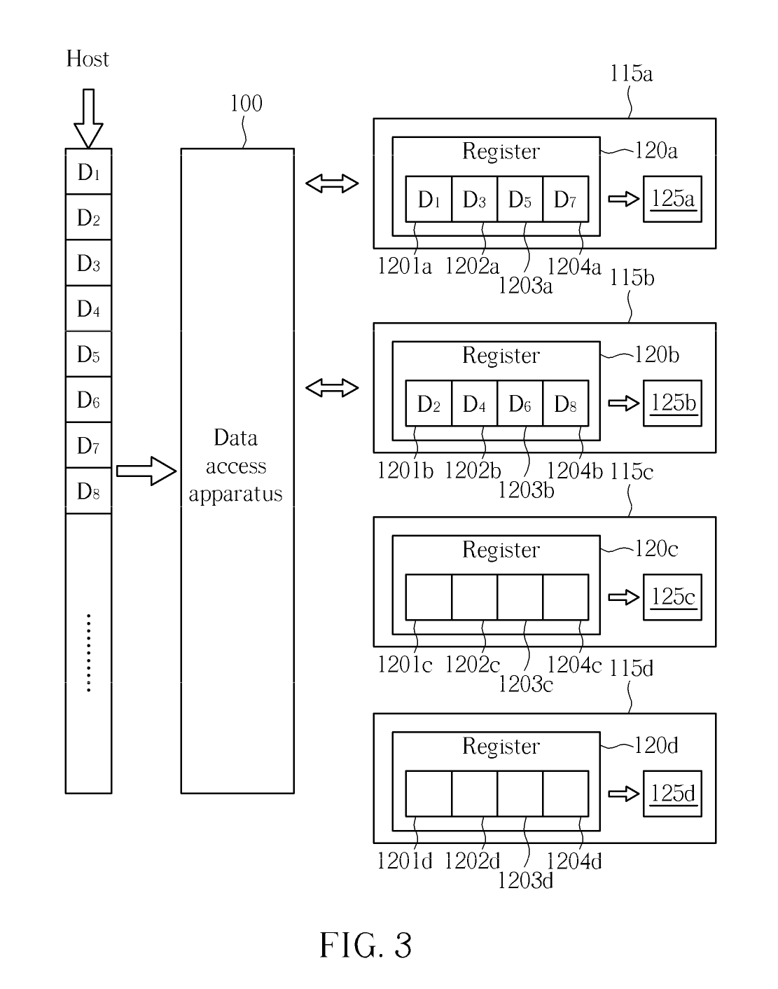

Furthermore, the present invention does not limit the host to performing data accessing upon all of the flash memory units synchronously when performing data writing. In another embodiment, the host can synchronously perform data accessing upon part of (i.e., not all of) the flash memory units when performing data writing operations. Please refer to FIG. 3. FIG. 3 is a diagram illustrating the access apparatus 100 shown in FIG. 1 which performs data writing operations upon part of the flash memory units. For example, when the host performs data writing operations, the control circuit 110 successively receives data D₁, D₃, D₅, D₇ and writes the data D₁, D₃, D₅, D₇ into the buffer areas 1051 of the buffer unit 105 through direct memory accessing, and also successively receives data D₂, D₄, D₆, Dₛ and writes the data D₂, D₄, D₆, Dₛ into the buffer areas 1052 of the buffer unit 105 through direct memory accessing. Next, the control circuit 110 reads the data D₁,D₂ from the buffer areas 1051, 1052, and respectively and synchronously writes the data D₁,D₂ into the buffering areas 1201a, 1201b of the internal registers 120a, 120b of the flash memory units 115a, 115b, and so forth. In this way, the control circuit 110 reads the data D₃-D₈, and writes the data D₃-Dₛ into the buffering areas 1202a, 1202b, 1203a, 1203b, 1204a, 1204b, as shown in FIG. 3.

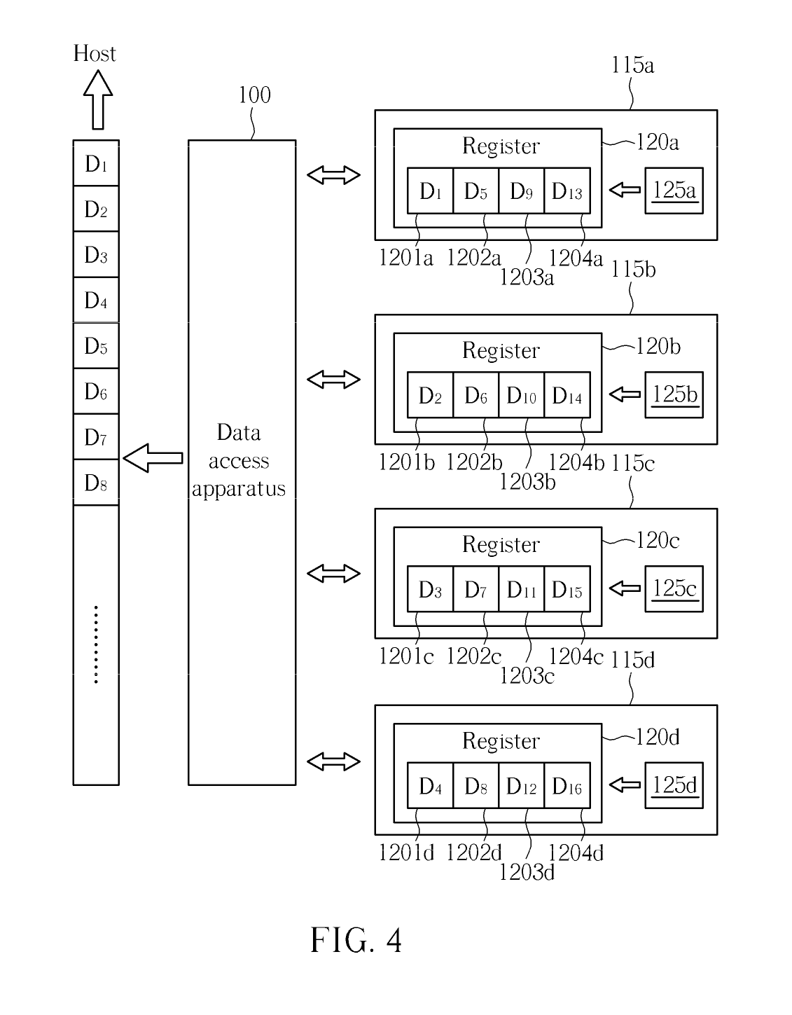

Please refer to FIG. 4. FIG. 4 is a diagram illustrating an operation of the data access apparatus 100 shown in FIG. 1 which performs data reading upon flash memory units. As mentioned above, the data access apparatus 100 respectively writes the data D₁-D₄ into the flash memory units 115a-115d, and so on. Therefore, if the data stream from the host further has multiple data D₅-D₁₆ (the data D₅-D₁₆ corresponding to continuous logical block addresses), the data D₅, D₉, D₁₃ are written into the flash memory unit 115a, the data D₆, D₁₀, D₁₄ are written into the flash memory unit 115b, the data D₇, D₁₁, D₁₅ are written into the flash memory unit 115c, and the data D₈, D₁₂, D₁₆ are written into the flash memory unit 115d. When the host wants to read the data D₅-D₁₆ from the flash memory units 115a-115d, each of the flash memory units 115a-115d reads the data from the corresponding physical sector block and temporarily stores the data into the corresponding internal register. For instance, the flash memory unit 115a reads the data from the corresponding physical sector block (denoted by reference numeral 125a) and temporarily stores the data into the registers 120a, where operations of the other flash memory units 115b-115d are the same as the flash memory unit 115a. Taking the flash memory unit 115a as an example, the sequence of the sector data temporarily stored in the registers 120a is D₁, D₅, D₉, D₁₃; regarding the other flash memory units 115b-115d, the sequence of the sector data temporarily stored in the registers 120b is D₂, D₆, D₁₀, D₁₄, the sequence of the sector data temporarily stored in the registers 120c is D₃, D₇, D₁₁, D₁₅, and the sequence of the sector data temporarily stored in the registers 120d is D₄, D_{g}, D₁₂, D₁₆, as shown in FIG. 4.

Therefore, the control circuit 110 of the data access apparatus 100 can respectively and synchronously read the data D₁-D₄ from the buffering areas 1201a-1201d of the internal registers 120a-120d of the flash memory units 115a-115d, store the data D₁-D₄ into the buffer unit 105, and then transmit the data D₁-D₄ to the host. Similarly, the data D₅-D₈, D₉-D₁₂, D₁₃-D₁₆ are also respectively and synchronously read by different flash memory units. Thus, assuming the transmission bandwidth between the host and the data access apparatus 100 is 150 mega bytes (MB), and the transmission bandwidth between an original flash memory unit and the data access apparatus 100 is 30 MB, as shown in FIG. 4, the data access apparatus 100 respectively and synchronously reads the sector data from the flash memory units 115a-115d, and the transmission bandwidth between the flash memory units 115a-115d and the data access apparatus 100 therefore can be enhanced to 120 MB; that is, the transmission bandwidth between the flash memory units 115a-115d and the data access apparatus 100 is greatly increased to quadruple that of the prior art data access technology. Because the transmission bandwidth between the flash memory units 115a-115d and the data access apparatus 100 (e.g., 120 MB) is closer to the transmission bandwidth between the host and the data access apparatus 100 (e.g., 150 MB), the buffer area of the buffer unit 105 in the data access apparatus 100 can be reduced to a quarter of the original size, which effectively decreases the hardware manufacturing cost of the data access apparatus 100. Please note that, although the buffer area of the buffer unit 105 is reduced to a quarter of the original size, the data access speed of the host will not be decreased, so the data reading efficiency can be maintained. Furthermore, the values of the transmission bandwidth mentioned above are merely examples for illustrating features of the present invention, and should not be considered as limitations to the scope of the present invention.

Moreover, as shown in FIG. 3, the data access apparatus 100 synchronously writes the data into the flash memory units 115a, 115b only, and when the host performs data reading operations, the data access apparatus 100 synchronously reads the corresponding data from the flash memory units 115a, 115b. Since this operation is similar to the data reading operation as shown in FIG. 4, the description is omitted here for the sake of brevity.

To summarize, the data access apparatus 100 of the present invention respectively and synchronously performs data accessing (reading or writing) operation upon a plurality of flash memory units, for performing data accessing upon the plurality of flash memory units at the same time. This not only shortens the data access delay time of the flash memory units effectively, but also achieves the objective of reducing the hardware manufacturing cost of the buffer unit.

Those skilled in the art will readily observe that numerous modifications and alterations of the device and method may be made while retaining the teachings of the invention.

What is claimed is:

1. A data access method employed in a multi-channel flash memory system, comprising:
respectively writing a plurality of data into a plurality of buffer areas of a buffer unit through direct memory accessing (DMA); and
sequentially reading the plurality of data from the plurality of buffer areas, and respectively and synchronously storing the plurality of data read from the plurality of buffer areas into the plurality of flash memory units;
wherein each of the plurality of data is a data block protected by an error correction code (ECC).

2. The data access method of claim 1, wherein the plurality of flash memory units comprises a first flash memory unit and a second flash memory unit different from the first flash memory unit, the plurality of data comprises a first data and a second data, and the step of respectively and synchronously storing the plurality of data read from the plurality of buffer areas into the plurality of flash memory units comprises:
synchronously storing the first data into the first flash memory unit and storing the second data into the second flash memory unit;
wherein the first data and second data correspond to two continuous logical addresses, respectively.

3. The data access method of claim 2, wherein the plurality of data further comprises a third data and a fourth data, and the step of respectively and synchronously storing the plurality of data read from the plurality of buffer areas into the plurality of flash memory units further comprises:
synchronously storing the third data into the first flash memory unit and storing the fourth data into the second flash memory unit;
wherein the first data, the second data, the third data and the fourth data correspond to four continuous logical addresses, respectively.

4. The data access method of claim 1, wherein the plurality of flash memory units comprises a first flash memory unit and a second flash memory unit different from the first flash memory unit, and the method further comprises:
reading a first data from the first flash memory unit and reading a second data from the second flash memory unit, synchronously;
wherein the first data and the second data correspond to two continuous logical addresses, respectively, and each of the first data and the second data is a data block protected by an error correction code.

5. The data access method of claim 4, wherein the plurality of flash memory units further comprises a third flash memory unit and a fourth flash memory unit, and the method further comprises:
reading a third data from the third flash memory unit and reading a fourth data from the fourth flash memory unit, synchronously;
wherein the first data, the second data, the third data and the fourth data correspond to four continuous logical addresses, respectively, and each of the third data and the fourth data is a data block protected by an error correction code.

6. A data access apparatus employed in a multi-channel flash memory system, the data access apparatus being coupled to a plurality of flash memory units, the data access apparatus comprising:
a buffer unit, including a plurality of buffer areas; and
a control circuit, coupled to the buffer unit, for controlling data reading/writing operations of the plurality of buffer areas of the buffer unit;
wherein the control circuit receives a plurality of data and respectively writes the plurality of data into the plurality of buffer areas of the buffer unit through direct memory accessing, and the control circuit reads the plurality of data from the plurality of buffer areas sequentially, and respectively and synchronously stores the plurality of data read from the plurality of buffer areas into the plurality of flash memory units, where each of the plurality of data is a data block protected by an error correction code (ECC).

7. The data access apparatus of claim 6, wherein the plurality of flash memory units comprises a first flash memory unit and a second flash memory unit different from the first flash memory unit, the plurality of data comprises a first data and a second data; and the control circuit reads the first data from the buffer unit and stores the first data into the first flash memory unit and reads the second data from the buffer unit and stores the second data into the second flash memory unit, synchronously, where the first data and the second data correspond to two continuous logical block addresses, respectively.

8. The data access apparatus of claim 7, wherein the plurality of data further comprises a third data and a fourth data; and the control circuit reads the third data from the buffer unit and stores the third data into the first flash memory unit and reads the fourth data from the buffer unit and stores the fourth data into the second flash memory unit, synchronously, where the first data, the second data, the third data and the fourth data correspond to four continuous logical block addresses, respectively.

9. The data access apparatus of claim 6, wherein the plurality of flash memory units comprises a first flash memory unit and a second flash memory unit different from the first flash memory unit; and the control circuit reads the first data from the first flash memory unit and stores the first data into the buffer unit and reads the second data from the second flash memory unit and stores the second data into the buffer unit, synchronously, where the first data and the second data correspond to two continuous logical block addresses, respectively, and each of the first data and the second data is a data block protected by an error correction code.

10. The data access apparatus of claim 9, wherein the plurality of flash memory units further comprises a third flash memory unit and a fourth flash memory unit; and the control circuit reads the third data from the third flash memory unit and stores the third data into the buffer unit and reads the fourth data from the fourth flash memory unit and stores the fourth data into the buffer unit, synchronously, where the first data, the second data, the third data and the fourth data correspond to four continuous logical block addresses, respectively, and each of the third data and the fourth data is a data block protected by an error correction code.
